(19) United States
(12) Patent Application Publication
(10) Pub. No.: US 2008/0245047 A1
(43) Pub. Date: Oct. 9, 2008

(54) Shredder head, and mobile silvicultural vehicle including the same

(76) Inventors: Gino Jobin, Normandin (CA); Louis-Philippe Nault, Dolbeau-Mistassini (CA)

Correspondence Address: ROBIC, CENTRE CDP CAPITAL, 1001, VICTORIA SQUARE - BLOC E - 8TH FLOOR, MONTREAL, QC, H2Z 2B7, CA

(21) Appl. No.: 11/783,083

(22) Filed: Apr. 5, 2007

(51) Int. Cl. A01B 29/06; A01D 34/42

(52) U.S. Cl. 56/504

(57) ABSTRACT

A shredder head for passing over a terrain containing vegetation and rocks so as to silviculturally process said terrain. The shredder head includes an elongated support shaft, a rotor, and a plurality of first and second sections provided longitudinally along a peripheral support surface area of the rotor. The second sections are each disposed between pairs of first sections so as to have an alternation of first and second sections longitudinally along the rotor. Each section includes at least one supporting element for supporting at least one processing tool configured for cooperating with the terrain via a rotation of the rotor for processing the terrain and corresponding vegetation and rocks present therein. First longitudinal gaps are defined between pairs of adjacent first sections, and second longitudinal gaps are defined between pairs of adjacent second sections, and the supporting elements and corresponding processing tools of these sections are shaped, positioned and sized within their respective sections so that the longitudinal gaps are smaller than longitudinal thicknesses of the corresponding processing tools so that rocks present in the terrain to be processed by the shredder head are impacted either by processing tools of adjacent sections or by processing tools of a same given section, so as to decrease average impact forces of the rocks per processing tool of the shredder head. The shredder head is also advantageous in that it is configured to be able to change the nature of the processing tools used therewith, without having to change the rotor or the corresponding supports of the processing tools.

### FIELD OF THE INVENTION

The present invention concerns a silvicultural tool used for the preparation of a terrain. More particularly, the present invention relates to a shredder head, and to a mobile silvicultural vehicle including the same.

### BACKGROUND OF THE INVENTION

Shredder heads for carrying out silvicultural applications are well known in the art. For example, in the beginning of the years 2000, several companies used shredders commercialized by Fecon™ or BullHog™. These conventional shredders are typically equipped with carbide hammers. There are also other manufactures of shredders such as FAE™. In fact, this company owns patents relatively to shredding devices, as exemplified by Canadian patent applications Nos. 2,466,714 and 2,466,721.

It is also well known in the art that a problem that is often encountered with these types of conventional shredders is the frequent wear and breaking of the carbide hammers. Typically, the tips of the carbides shatter during violent impacts with rocks and the like present in the field or terrain to be processed. However, it is also known in the art that it is difficult to use a chipping head with steel hammers without carbides because during normal utilization thereof, these hammers use themselves very quickly and furthermore, the quality of shredding resulting from hammers having been rounded off by wear thus becomes very poor. This situation causes maintenance costs of known shredders being employed currently in the market to be very high, due to namely a great number of time wasted and high replacement costs of carbide hammers, etc.

Also known in the art are the various drawbacks and disadvantages associated with conventional rotors which are used in the silvicultural field for the preparation of terrains and the like.

For example, a problem associated with conventional rotors, is that the latter are equipped, either with carbide hammers, or with sharpened knives, whereas with respect to known hybrid rotors, the knives are generally not completely free to be removably interchanged, which essentially results in the decrease of the efficiency of the rotor for certain applications. For other known rotors provided with knives, which are more frequent in the market, they are not efficient because when there is the presence of rocks or other undesirable objects in the terrain to be processed, the knives become destroyed or at the very least deteriorate themselves due to the impacts with the rocks or other undesirable objects present in the given field. There is thus a substantial need to overcome this problem, that is, to find a shredder design having a high tolerance to rocks and the like, and the capacity of effectively cutting vegetation, without having necessarily to change rotor on the silvicultural vehicle, for example.

It is also known in the art that the disposition of cutting tools, or of carbide hammers, on the rotor, has a significant impact on the efficiency of the rotor. Currently, manufacturers each have a disposition design of either hammers or knives on the rotor. For example, Deniscimat-Gyro-Trac™ has a linear configuration, whereas others, such as FAE™, have a configuration which seems somewhat random, whereas even others such as Gyro-trac™ have a spiral configuration. These different configurations are generally the result of trials and errors during development phases.

The main problem associated with these conventional fixed configurations, is that for one site to the other, or from one given silvicultural application to another, the rotor must be changed in order to optimise the corresponding rotor to the concerned application. For example, in a field where one has to cut a lot of thick wood, a linear configuration would not be optimal because the demand for energy is very significant. Conversely, in a terrain or a field where there are a lot of small bushes, a spiral configuration is not optimal, because by adding a greater number of knives disposed linearly, one would have a greater speed of advancement and a greater cut or processing of the terrain.

Furthermore, it is known in the art that traditionally, there have been two (2) main schools of thoughts with respect to the use of processing tools to be employed with conventional rotors: some have always employed rotors provided exclusively with carbide hammers, typically appropriate for certain silvicultural applications, whereas others have always employed rotors provided exclusively with cutting knives, typically appropriate for other silvicultural applications, but no one has ever suggested a new and innovative rotor with corresponding supports which would enable an interchangeability of processing tools, without having to change the entire rotor or undertake other corresponding measures, which very often result in substantial drawbacks, such as downtime and the like.

Hence, in light of the aforementioned, there is a need for a device, which by virtue of its design and components, would be able to overcome some of the above-discussed prior art problems.

### SUMMARY OF THE INVENTION

An object of the present invention is to provide a shredder head, which by virtue of its design and components, satisfies some of the above-mentioned problems and is thus an improvement over other related shredder heads and/or shredding methods known in the prior art.

In accordance with the present invention, the above object is achieved, as will be easily understood, with a shredder head, such as the one briefly described herein, and such as the one exemplified in the accompanying drawings.

More particularly, according to the present invention, there is provided a shredder head for a passing over a terrain containing vegetation and rocks so as to silviculturally process said terrain, the shredder head comprising:

an elongated support shaft about which the shredded head is mounted and configured to rotate;

a rotor mounted about the elongated support shaft and extending along the same, the rotor having a peripheral support surface area and a longitudinal axis of rotation; and

a plurality of first and second sections provided longitudinally along the peripheral support surface area of the rotor, each of said sections extending transversally with respect to the longitudinal axis of rotation of said rotor, the second sections being each disposed between pairs of first sections so to have an alternation of first and second sections longitudinally along the rotor, each of said sections comprising at least one supporting element for supporting at least one processing tool configured for cooperating with the terrain via a rotation of the rotor for processing said terrain and corresponding vegetation and rocks;

wherein first longitudinal gaps are defined between pairs of adjacent first sections, and second longitudinal gaps are defined between pairs of adjacent second sections, the supporting elements and corresponding processing tools of the first and second sections being shaped, positioned and sized within their respective sections so that the longitudinal gaps are smaller than longitudinal thicknesses of the corresponding processing tools so that rocks present in the terrain to be processed by the shredder head are impacted either by processing tools of adjacent sections or by processing tools of a same given section, so as to decrease average impact forces of the rocks per processing tool of the shredder head.

Preferably, the rotor of the shredder head comprises different longitudinal segments, including a center segment, having different densities of processing tools, and the center segment has a density of processing tools greater than the densities of processing tools of remaining segments, the center segment being provided with a plurality of first and second sections, each of said sections comprising a plurality of supporting elements for supporting each a corresponding processing tool.

Preferably also, the remaining segments are provided with a plurality of first and second sections, each of said sections comprising a single supporting element for supporting each a single processing tool.

Preferably also, the first and second sections of the center segment each comprise four supporting elements and corresponding processing tools per section, said four supporting elements and corresponding processing tools being positioned equidistantly with respect to one another within a same section about the peripheral support surface area of the rotor.

Preferably also, positioning of the processing tools of the first sections are rotatably offset about the rotor with respect to positioning of the processing tools of the second sections.

Preferably also, the supporting elements comprise support flanges defining corresponding recesses for receiving the processing tools therein, and the fasteners are insertable through the corresponding support flanges of the supporting elements and fastenable into rear portions of the processing tools resting against the recesses.

Preferably also, the processing tools are selected from the group consisting of hammers, knifes and a combination of hammers and knifes. Preferably also, the processing tools are carbide tools.

According to another aspect of the present invention, there is also provided a shredder head for a passing over a terrain containing vegetation and rocks so as to silviculturally process said terrain, the shredder head comprising:

an elongated support shaft about which the shredded head is mounted and configured to rotate;

a rotor mounted about the elongated support shaft and extending along the same, the rotor having a peripheral support surface area and a longitudinal axis of rotation; and

a plurality of sections provided longitudinally along the peripheral support surface area of the rotor, each of said sections extending transversally with respect to the longitudinal axis of rotation of said rotor, each of said sections comprising at least one supporting element for supporting at least one processing tool configured for cooperating with the terrain via a rotation of the rotor for processing said terrain and corresponding vegetation and rocks;

wherein each supporting element is configured so that different processing tools may be selectively and removably mounted thereon.

Preferably, the processing tools are selected from the group consisting of hammers, knifes and a combination of hammers and knifes, and the processing tools all substantially weigh the same.

According to yet another aspect of the present invention, there is also provided a mobile silvicultural vehicle for traveling over a terrain, to be treated and containing vegetation and rocks, so as to process said terrain, the mobile silvicultural vehicle comprising:

a steerable wheeled base frame;

a motor for imparting motion to the base frame; and

a least one shredder head operatively mounted onto the base frame and configured for processing the terrain as the mobile silvicultural vehicle travels thereover, each shredder head comprising:
an elongated support shaft about which the shredded head is mounted and configured to rotate;
a rotor mounted about the elongated support shaft and extending along the same, the rotor having a peripheral support surface area and a longitudinal axis of rotation; and
a plurality of first and second sections provided longitudinally along the peripheral support surface area of the rotor, each of said sections extending transversally with respect to the longitudinal axis of rotation of said rotor, the second sections being each disposed between pairs of first sections so to have an alternation of first and second sections longitudinally along the rotor, each of said sections comprising at least one supporting element for supporting at least one processing tool configured for cooperating with the terrain via a rotation of the rotor for processing said terrain and corresponding vegetation and rocks;
wherein first longitudinal gaps are defined between pairs of adjacent first sections, and second longitudinal gaps are defined between pairs of adjacent second sections, the supporting elements and corresponding processing tools of the first and second sections being shaped, positioned and sized within their respective sections so that the longitudinal gaps are smaller than longitudinal thicknesses of the corresponding processing tools so that rocks present in the terrain to be processed by the shredder head are impacted either by processing tools of adjacent sections or by processing tools of a same given section, so as to decrease average impact forces of the rocks per processing tool of the shredder head.

According to yet another aspect of the present invention, there is also provided a method of operating the above-mentioned shredder head and/or mobile silvicultural vehicle for preparing a terrain.

According to another aspect of the present invention, there is also provided a terrain having been prepared with the above-mentioned shredder head, mobile silvicultural vehicle and/or corresponding method of operation, as well as any tree or vegetation from the terrain having grown afterwards.

The objects, advantages and other features of the present invention will become more apparent upon reading of the following non-restricted description of preferred embodiments thereof, given for the purpose of exemplification only, with reference to the accompanying drawings.

### BRIEF DESCRIPTION OF THE DRAWINGS

FIG. 1 is a front view of a shredder head according to a preferred embodiment of the present invention.

FIG. 2 is a side view of what is shown in FIG. 1.

FIG. 3 is an enlarged view of a section of what is shown in FIG. 2.

FIG. 4 is a side view of a mobile silvicultural vehicle provided with a pair of shredder heads according to a preferred embodiment of the present invention.

FIG. 5 is a top view of what is shown in FIG. 4.

FIG. 6 is a side view of a supporting element of a processing tool according to another preferred embodiment of the present invention.

FIG. 7 is a front view of what is shown in FIG. 6.

FIG. 8 is a partial sectional view of a portion of the supporting element shown in FIG. 6.

### DETAILED DESCRIPTION OF PREFERRED EMBODIMENTS OF THE INVENTION

In the following description, the same numerical references refer to similar elements. The embodiments, features, dimensions and/or geometrical dispositions, described in the present application and/or illustrated in the accompanying figures, are preferred, and are used for exemplification purposes only.

Moreover, although the present invention was primarily designed for silvicultural purposes, and more particularly for site preparation and land-clearing, as is well known in the art, it may be used with other types of objects, and for other purposes and in other fields, such as for agricultural purposes, and the like, for example, as apparent to a person skilled in the art. For this reason, expressions such as “shredder”, “silvicultural”, “land”, “vegetation”, “tree”, “brush”, etc. as used herein should not be taken as to limit the scope of the present invention and includes all other kinds of items and/or purposes with which the present invention could be used and may be useful, as also apparent to a person skilled in the art.

Furthermore, although the present invention was primarily designed for carrying out silvicultural applications on site, that is, in the forest for example, by means of a silvicultural apparatus, including for example, a shredder head attached to an excavator, or any other suitable device cooperating with a proper vehicle, etc., the present invention could be used with other equipment and in other fields, such as for agricultural purposes, as aforementioned, and as apparent to a person skilled in the art. For these reasons, expressions such as “tree”, “forest”, “excavator”, “shredder head”, “rotor” and/or any other reference and/or any other equivalent or similar expression to the latter should not be considered as limiting the scope of the present invention, and include all other objects and/or all other applications with which the present invention could be used and may be useful, as also apparent to a person skilled in the art.

Moreover, in the context of the present invention, the expressions “shredder”, “head”, “mulcher”, “rotor”, “assembly”, “device”, “apparatus”, and any other equivalent expressions known in the art will be used interchangeably. Furthermore, the same applies for any mutually equivalent expressions, such as “field”, “land”, “ground” and “terrain”, as well as “prepare”, “treat” and “process” for example, as well as “tree”, “vegetation”, “bush” and “brush”, as also apparent to a person skilled in the art.

In addition, although the preferred embodiment of the shredder head 1 as illustrated in the accompanying drawings comprises various components and although the preferred embodiment of the shredder head 1 and corresponding mobile silvicultural vehicle 3 as shown consist of certain geometrical configurations as briefly explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the shredder head 1, mobile silvicultural vehicle 3 and corresponding parts according to the present invention, as briefly explained and as can be easily inferred herefrom by a person skilled in the art, without departing from the scope of the present invention.

Broadly described, the shredder head 1 (also referred to herein as “shredding rotor assembly”) according to the present invention, as shown in the accompanying drawings, is an improved shredder head 1 comprising different components and features, destined to be used with a mobile silvicultural apparatus or vehicle 3 in order to carry out a preparation process for a terrain to be treated, according to well known silvicultural principles.

The Applicant of the present application has also developed a solution for carrying out mechanically a pre-commercial clearing with a silvicultural apparatus or vehicle 3, and corresponding processes, which are better described and illustrated in U.S. Pat. No. 6,550,505, U.S. Pat. No. 6,698,478 and U.S. Pat. No. 6,945,025, the contents of which are all incorporated herein by reference. Furthermore, the present application essentially covers the subject matter of priority documents Nos. CA 2,524,021 and CA 2,534,413 filed by this very same Applicant, the contents of which are also all incorporated herein by reference.

Indeed, for a number of several years now, this same Applicant manufactures its own shredders. These shredders are designed so as to carry out the preparation of a given terrain. Carbide hammers are preferably used for shredding the vegetation and penetrating into the ground. This method being commonly known as “shredding”. Since the hammers operate close to the ground or penetrate the same, the vegetation is well smashed and grinded. However, the shredders of the prior art, such as those of FAE™ and FECON™, like most other shredders in the market, are not very resistant to impacts with rocks and the like which may be present on or within the ground to be treated.

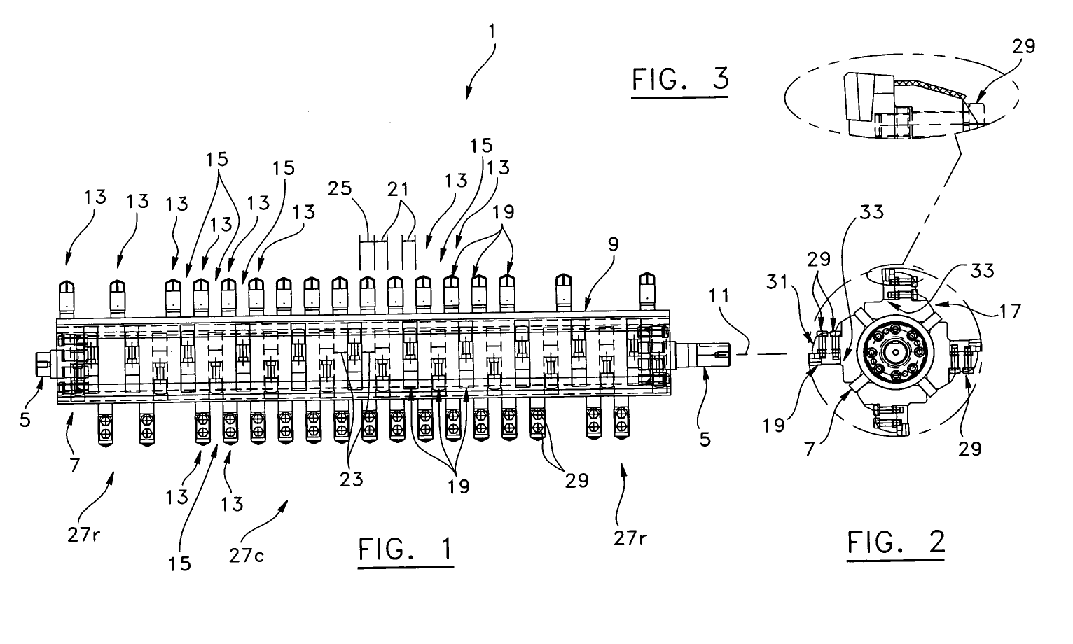

Thus, according to the present invention, there is provided a shredder head 1 for a passing over a terrain containing vegetation and rocks so as to silviculturally process said terrain. The shredder head 1 comprises an elongated support shaft 5 about which the shredded head 1 is mounted and configured to rotate. The shredder head 1 also comprises a rotor 7 mounted about the elongated support shaft 5 and extending along the same, the rotor 7 having a peripheral support surface area 9 and a longitudinal axis 11 of rotation. The shredder head 1 also comprises a plurality of first and second sections 13,15 provided longitudinally along the peripheral support surface area 9 of the rotor 7, each of said sections 13,15 extending transversally with respect to the longitudinal axis 11 of rotation of said rotor 7, the second sections 15 being each disposed between pairs of first sections 13 so to have an alternation of first and second sections 13,15 longitudinally along the rotor 7, as better shown in FIG. 1, each of said sections 13,15 comprising at least one supporting element 17 for supporting at least one processing tool 19 configured for cooperating with the terrain via a rotation of the rotor 7 for processing said terrain and corresponding vegetation and rocks, as can be easily understood when referring to FIG. 2 also.

According to the present invention, first longitudinal gaps 21 are defined between pairs of adjacent first sections 13, and second longitudinal gaps 23 are defined between pairs of adjacent second sections 15, the supporting elements 17 and corresponding processing tools 19 of the first and second sections 13,15 being shaped, positioned and sized within their respective sections 13,15 so that the longitudinal gaps 21,23 are smaller than longitudinal thicknesses 25 of the corresponding processing tools 19 so that rocks present in the terrain to be processed by the shredder head 1 are impacted either by processing tools 19 of adjacent sections 13,15 or by processing tools of a same given section 13,15, so as to decrease average impact forces of the rocks per processing tool 19 of the shredder head 1.

Preferably, and as better shown in FIG. 1, the rotor 7 of the shredder head 1 comprises different longitudinal segments 27, including a center segment 27c, having different densities of processing tools 19, and the center segment 27c preferably has a density of processing tools 19 greater than the densities of processing tools 19 of remaining segments 27r, the center segment 27c being provided with a plurality of first and second sections 13,15, each of said sections 13,15 comprising a plurality of supporting elements 17 for supporting each a corresponding processing tool 19.

Preferably also, the remaining segments 27r are provided with a plurality of first and second sections 13,15, each of said sections 13,15 preferably comprising a single supporting element 17 for supporting each a single processing tool 19.

Preferably also, and as better shown in FIG. 2, the first and second sections 13,15 of the center segment 27c each comprise four supporting elements 17 and corresponding processing tools 19 per section 13,15, said four supporting elements 17 and corresponding processing tools 19 being preferably positioned equidistantly with respect to one another within a same section 13,15 about the peripheral support surface area 9 of the rotor 7.

Preferably also, positioning of the processing tools 19 of the first sections 13 are rotatably offset about the rotor 7 with respect to positioning of the processing tools 19 of the second sections 15, as better shown in FIG. 1. Preferably also, the remaining segments 27r comprise a pair of end segments provided on each side of the center segment 27c.

Preferably also, and as better shown in FIGS. 2 and 3, the processing tools 19 are removably mountable onto the supporting elements 17 via corresponding fasteners 29. Preferably also, the supporting elements 17 comprise support flanges 31 defining corresponding recesses 33 for receiving the processing tools 19 therein, the fasteners 29 being preferably insertable through the corresponding support flanges 31 of the supporting elements 17 and fastenable into rear portions of the processing tools 19 resting against the recesses 33. Preferably also, the rotor 7 has machined portions for receiving the supporting elements 17 thereon.

Preferably also, the processing tools 19 are selected from the group consisting of hammers, knifes and a combination of hammers and knifes. The processing tools 19 may be also carbide tools.

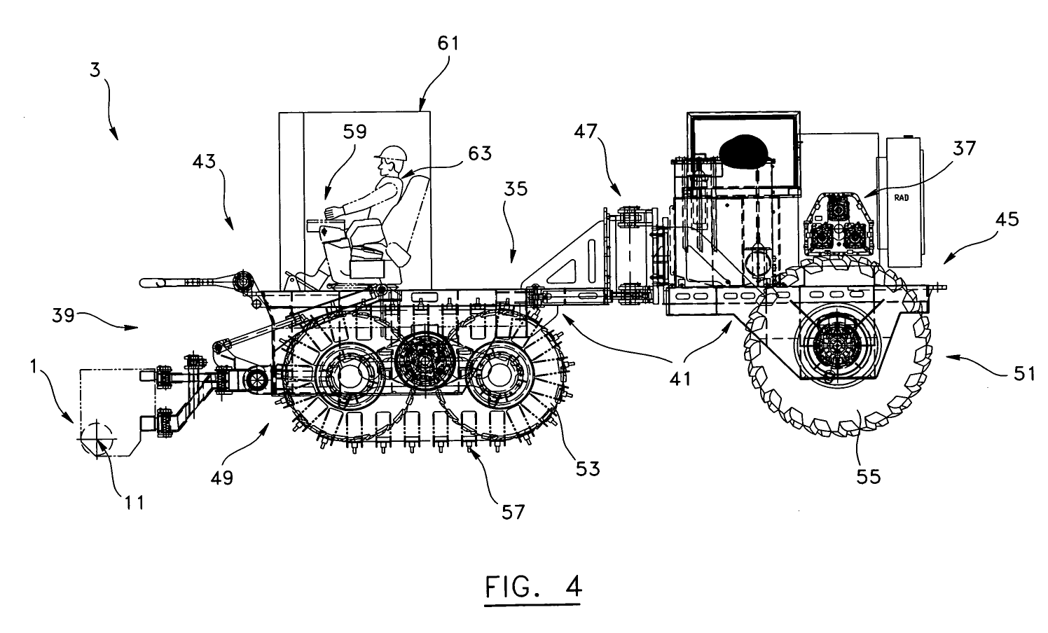

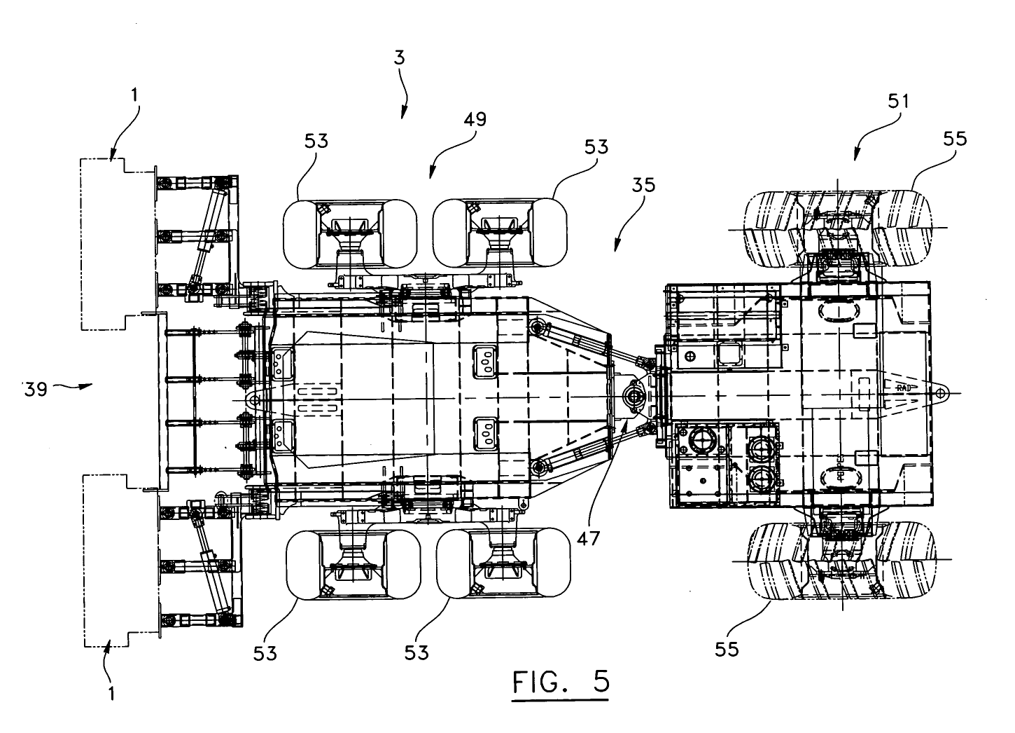

The shredding rotor assembly, as better exemplified in FIGS. 1-3, and the corresponding mobile silvicultural vehicle 3 with which it is intended to be used, as better exemplified in FIGS. 4 and 5, according to the present invention, is preferably used in a semi-mechanized pre-commercial land-clearing process and/or in a land-clearing process. In either one of these processes, an aim is to shred the vegetation at ground level. As previously explained, a major problem encountered with conventional rotors is the frequent wear and breaking of carbide hammers (the tips of the carbides burst during violent impacts with rocks and the like), which is very disadvantageous because this situation in turn causes the maintenance fees of shredder to be very elevated, due to namely a great number of time wasted and very high replacement costs for the carbide hammers, etc.

In order to overcome this substantial problem, and resulting undesirable effects, an object of the present invention is to provide for an improved shredder rotor assembly design which would have a greater tolerance to such rocks and the like. The present invention thus proposes an improved shredding rotor assembly with processing tools 19 and a particular configuration resistant to undesirable debris, such as rocks and the like. Preferably, and as previously explained, the shredder head 1 is provided with carbide knives or hammers. This disposition of these carbide tools is such that the carbide knives protect themselves mutually by decreasing the average impact by hammer, as can be easily understood by a person skilled in the art when referring to FIGS. 1-3. Indeed, when a carbide hammer according to the present invention impacts a rock, this impact is substantially reduced by the fact that there is another hammer following behind within a given same section 13,15 or there is another hammer disposed adjacent thereto, in a neighboring section 15,13, so as to absorb a portion of the impact. This is substantially different from what is done in the prior art in that the impact is mainly concentrated on a single hammer per section. As may now be better appreciated by a person skilled in the art in view of the present description and the accompanying drawings, the rotor 7 according to the present invention is thus an improved rotor 7 where a balance is achieved between the number of hammers and the capacity of the rotor 7 to cut and smash vegetation, this being due to the number of processing tools 19 (e.g. hammers) and the disposition of the processing tools 19 on the rotor 7, as better exemplified in FIGS. 1-3. Preferably also, and as can be easily understood by a person skilled in the art, the number of processing tools 19 provided on the rotor 7 is done according to the diameter of the rotor 7 and the quantity of rocks present on the terrain to be treated. Thus, for example, if a great number of hammers are provided, then the rotor 7 benefits from the “cylinder” effect. With a great number of hammers, the rotor 7 thus acts as a cylinder rather than a rotor 7 for shredding.

According to the preferred embodiment of the present invention, the hammers are preferably distributed along four (4) different rows, and on two (2) of these rows, a greater number of hammers are preferably provided, as exemplified in FIGS. 1-3. A goal and corresponding advantage thereof is to distribute the shock or impact with a given rock or the like, on more than one given hammer. Preferably also, on the four (4) rows there is preferably provided a greater number of hammers towards the center portion of the rotor 7. Indeed, it is important to remember, as is well known in the art, that generally, the center of the rotor 7 is the critical zone for the impacts with rocks and the like. Thus, generally and preferably, an improved aspect of the present invention is that it enables to concentrate hammers there where they are more in need and to aim at distributing or minimizing the impacts on more than one given hammer at a time. Thus, it now may be better appreciated that this particular design of the rotor 7 is thus a significant innovative aspect of the present invention.

This innovation can be used on a variety of conventional shredding devices known in the art, such as for example, the heads commercialized by FECON™ and AHWI™ (rotor on pallet), and those commercialized by FAE™ (cylindrical rotor). In fact, the present invention enables to significantly improve the work capacity attainable by these conventional shredder heads during a shredding application of the vegetation at ground level with the presence of rocks and the like, such as for example, in the case of shredding-chipping by band for semi-mechanized pre-commercial land-clearing and site preparation and land-clearing.

The present invention can also be used for several other well known silvicultural applications, as apparent to a person skilled in the art.

It is also worth mentioning that several modifications could be made to the present shredding rotor assembly according to the present invention, as apparent to a person skilled in the art. For example, the processing tools 19 that are used could be carbide hammers, or cutting knives, or a combination of both, or others. Furthermore, the number of tools 19 which are mounted onto the shredding rotor assembly and/or the manner in which they may be mounted thereon can be varied, as can also be easily understood by a person skilled in the art.

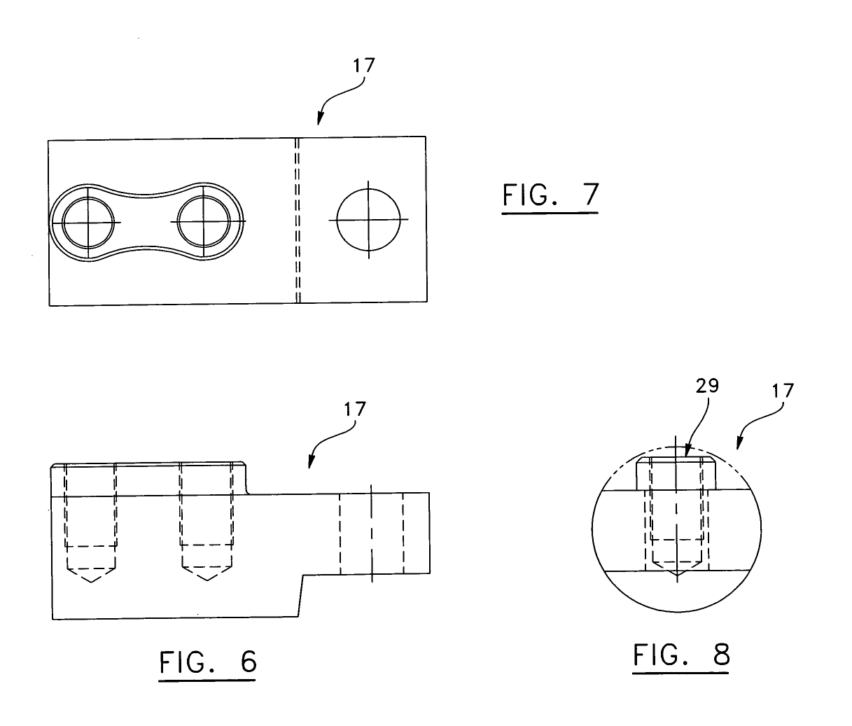

For example, and as be easily understood when referring to FIGS. 6-8, each supporting element 17 of a given processing tool 19, whether a hammer and/or a knife, could preferably comprise at least two (2) components, namely a first component (“primary” support) which would be fixed to the rotor (preferably, in a welded manner), and a second component (“secondary” support) which would be fixed to the first component (preferably, in a removable manner, such as via bolts and the like). Furthermore, with respect to the processing tools 19, whether they be hammers and/or knives, they would be preferably made so that both of them could be removably attached or fixed (i.e. “boltable”) to the second component of the supporting element 17. One can thus, according to the present invention, mount onto the rotor 7 either hammers (preferably not those of the conventional kind, but rather some similar to knives in respect to attachment), either knives, or a combination of both. Preferably also, the hammers and/or knives used for the present invention are of the same weight, which enables to advantageously prevent an unbalancement of the rotor 7 in question, irrespectively of the nature of the processing tools 19 being used, as apparent to a person skilled in the art.

Another important aspect of the present invention resides in the flexibility of the present rotor 7 to be equipped with either knives or hammers, this flexibility being preferably provided from the design of the aforementioned primary and secondary supports of the corresponding supporting elements 17 of the processing tools 19 (hammers/knives). In fact, one could vary the number and the nature of processing tools 19, as well as their disposition on the rotor 7, namely their configuration, so as to obtain a hybrid rotor 7 with variable configuration as is only possible with the components and features of the present invention, as described herein. With this particular innovation, one can mount onto the rotor 7 processing tools 19 either in a linear manner, in a spiral manner, in a mixture of both, or along different configurations according to the particular application for which the rotor 7 and corresponding mobile silvicultural vehicle 3 are intended, as apparent to a person skilled in the art.

Another important aspect of the present invention consists in the fact that the rotor 7 is preferably provided with the above-mentioned supporting elements 17 for alternatively receiving knives and/or hammers, as aforementioned. Indeed, as better exemplified in FIGS. 6-8, the supporting elements 17 of the hammers/knives according to a preferred embodiment of the present invention, preferably comprise, as aforementioned, at least two (2) main components, namely a “primary” support being preferably securely affixed to the rotor 7, and a “secondary” support being preferably removably mountable onto the primary support.

As may now be better appreciated, the above-mentioned variations of the present invention are particularly advantageous in that they enable to significantly increase the working capacity of the shredder head during a silvicultural processing such as shredding at ground level, for example, with the presence of rocks. Furthermore, the present invention is particularly advantageous in that it can also be used on a variety of different silvicultural applications or of shredder heads, such as for example those of FECON™ and AHWI™, whether for site preparation, land-clearing, and/or the like.

Several other modifications could be made to the present shredding rotor assembly according to the present invention, without departing from the scope thereof, as also apparent to a person skilled in the art. For example, the total length of the rotor 7 could be varied, as well as its diameter, depending on the particular applications for which the present shredding rotor assembly is intended for. The length of the rotor 7 provided with tools 19 could have a greater diameter and the length of the rotor 7 having a smaller diameter could also be varied. The base structure of the rotor 7 can be of different form and shape as that of the one illustrated in the accompanying drawings, such as a tube, flat metal components, etc. Furthermore, the rotor 7 according to the present invention is not necessarily limited to a central section provided with a greater number of hammers, but could comprise several sections having each an agglomeration of such hammers, and an interposition between these different sections varied depending on the particular applications for which the rotor 7 is intended for, as apparent to a person skilled in the art. If need may be, and according to the present invention, the different sections of the rotor 7 could be displaceable and variable by means of appropriate mechanisms, as also apparent to a person skilled in the art.

According to another aspect of the present invention, there is also provided a mobile silvicultural vehicle 3 for traveling over a terrain, to be treated and containing vegetation and rocks, so as to process said terrain, the mobile silvicultural vehicle 3 comprising a steerable wheeled base frame 35, a motor 37 for imparting motion to the base frame 35, and a least one shredder head 1 operatively mounted onto the base frame 35 and configured for processing the terrain as the mobile silvicultural vehicle 3 travels thereover, as better shown in FIGS. 5 and 6.

Preferably, the steerable wheeled base frame 35 comprises a horizontally extending ground-clearing section 39, and first and second opposite vertical side sections 41.

Preferably also, the ground-clearing and side sections 39,41 define a tunnel-shaped passage through which immature trees of the terrain are allowed to pass as the base frame 35 travels thereover, the base frame 35 further comprising front and rear units 43,45 and a universal joint 47 coupling the front unit 43 to the rear unit 451 front and rear-wheeled assemblies 49,51 mounted respectively to the front and rear units 43,45 of the base frame 35, the front wheeled assembly 49 comprising left and right front wheels 53 respectively mounted to the vertical side sections 41 of the front unit 43, and the rear wheeled assembly 51 comprising left and right rear wheels 55 mounted respectively to the vertical side sections 41 of the rear unit 45.

Preferably, the front wheels 53 are hydrostatic motor-wheels. Preferably also, the hydrostatic motor-wheels are provided with chain threads 57.

Preferably also, the mobile silvicultural vehicle 3 comprises control means 59 for controlling the steerable base frame 35 and the motor 7. Preferably also, the front unit 43 of the support frame 35 comprises a cabin 61 for housing an operator 63 of the mobile silvicultural vehicle 3.

Mobile silvicultural vehicles 3 are well known in the art, and thus, their working principle and design thereof, as well as possible variants that can be used therewith, need not to be further discussed in the context of the present description, as apparent to a person skilled in the art.

As may now be better appreciated, in light of the aforementioned, the present invention is particularly advantageous in that it enables different manners, and provides different alternatives of mechanical equipment, for treating a terrain so as to be able to plant therein trees, vegetation and the like, and thus avoid a great loss of productive terrain which is normally wasted with conventional shredders. Indeed, the process according to the present invention enables namely to use terrains covered by different piles of accumulated material, such as branches and the like, and to treat them and prepare them so as to enable to plant therein several other trees, and thus enable to aid the regeneration of the forest of tomorrow. Furthermore, the present invention is also advantageous in that the rotor 7, by virtue of its design and components, as briefly described in the present application, and exemplified in the accompanying drawings, enables to provide a variety of different configurations, as well as to substantially reduce the energy consumed and the power required for operation thereof, without necessarily compromising the processing of terrain according to the intended and well known silvicultural principles. Furthermore, and as may now also be better appreciated, the present invention is also a substantial improvement over the prior art in that the shredder head 1 and corresponding rotor 7 are designed, as explained hereinabove, so as to be able to change the nature of the processing tool 19 used with the rotor, whether it be a carbide hammer, a cutting knife, or other, without having to change the rotor 7 itself, or the supporting element 17 of the processing tool 19.

Of course, numerous modifications could be made to be above-described embodiments without departing from the scope of the present invention, as defined in the appended claims.

1. A shredder head for a passing over a terrain containing vegetation and rocks so as to silviculturally process said terrain, the shredder head comprising:
an elongated support shaft about which the shredded head is mounted and configured to rotate;
a rotor mounted about the elongated support shaft and extending along the same, the rotor having a peripheral support surface area and a longitudinal axis of rotation; and
a plurality of first and second sections provided longitudinally along the peripheral support surface area of the rotor, each of said sections extending transversally with respect to the longitudinal axis of rotation of said rotor, the second sections being each disposed between pairs of first sections so to have an alternation of first and second sections longitudinally along the rotor, each of said sections comprising at least one supporting element for supporting at least one processing tool configured for cooperating with the terrain via a rotation of the rotor for processing said terrain and corresponding vegetation and rocks;
wherein first longitudinal gaps are defined between pairs of adjacent first sections, and second longitudinal gaps are defined between pairs of adjacent second sections, the supporting elements and corresponding processing tools of the first and second sections being shaped, positioned and sized within their respective sections so that the longitudinal gaps are smaller than longitudinal thicknesses of the corresponding processing tools so that rocks present in the terrain to be processed by the shredder head are impacted either by processing tools of adjacent sections or by processing tools of a same given section, so as to decrease average impact forces of the rocks per processing tool of the shredder head.

2. A shredder head according to claim 1, wherein the rotor of the shredder head comprises different longitudinal segments, including a center segment, having different densities of processing tools, and wherein the center segment has a density of processing tools greater than the densities of processing tools of remaining segments, the center segment being provided with a plurality of first and second sections, each of said sections comprising a plurality of supporting elements for supporting each a corresponding processing tool.

3. A shredder head according to claim 2, wherein the remaining segments are provided with a plurality of first and second sections, each of said sections comprising a single supporting element for supporting each a single processing tool.

4. A shredder head according to claim 2, wherein the first and second sections of the center segment each comprise four supporting elements and corresponding processing tools per section, said four supporting elements and corresponding processing tools being positioned equidistantly with respect to one another within a same section about the peripheral support surface area of the rotor.

5. A shredder head according to claim 1 wherein positioning of the processing tools of the first sections are rotatably offset about the rotor with respect to positioning of the processing tools of the second sections.

6. A shredder head according to claim 3, wherein the remaining segments comprise a pair of end segments provided on each side of the center segment.

7. A shredder head according to claim 1, wherein the processing tools are removably mountable onto the supporting elements via corresponding fasteners.

8. A shredder head according to claim 7, wherein the supporting elements comprise support flanges defining corresponding recesses for receiving the processing tools therein, and wherein the fasteners are insertable through the corresponding support flanges of the supporting elements and fastenable into rear portions of the processing tools resting against the recesses.

9. A shredder head according to claim 1, wherein the processing tools are selected from the group consisting of hammers, knifes and a combination of hammers and knifes.

10. A shredder head according to claim 3, wherein the remaining segments comprise a pair of end segments provided on each side of the center segment; wherein the first and second sections of the center segment each comprise four supporting elements and corresponding processing tools per section, said four supporting elements and corresponding processing tools being positioned equidistantly with respect to one another within a same section about the peripheral support surface area of the rotor; and wherein positioning of the processing tools of the first sections are rotatably offset about the rotor with respect to positioning of the processing tools of the second sections.

11. A shredder head according to claim 12, wherein the processing tools are removably mountable onto the supporting elements via corresponding fasteners; wherein the supporting elements comprise support flanges defining corresponding recesses for receiving the processing tools therein, and wherein the fasteners are insertable through the corresponding support flanges of the supporting elements and fastenable into rear portions of the processing tools resting against the recesses; wherein the processing tools are selected from the group consisting of hammers, knifes and a combination of hammers and knifes; wherein the processing tools are carbide tools; and wherein the rotor has machined portions for receiving the supporting elements thereon.

12. A shredder head for a passing over a terrain containing vegetation and rocks so as to silviculturally process said terrain, the shredder head comprising:
an elongated support shaft about which the shredded head is mounted and configured to rotate;
a rotor mounted about the elongated support shaft and extending along the same, the rotor having a peripheral support surface area and a longitudinal axis of rotation; and
a plurality of sections provided longitudinally along the peripheral support surface area of the rotor, each of said sections extending transversally with respect to the longitudinal axis of rotation of said rotor, each of said sections comprising at least one supporting element for supporting at least one processing tool configured for cooperating with the terrain via a rotation of the rotor for processing said terrain and corresponding vegetation and rocks;
wherein each supporting element is configured so that different processing tools may be selectively and removably mounted thereon.

13. A shredder head according to claim 12, wherein the processing tools are selected from the group consisting of hammers, knifes and a combination of hammers and knifes, and wherein the processing tools all substantially weigh the same.

14. A mobile silvicultural vehicle for traveling over a terrain, to be treated and containing vegetation and rocks, so as to process said terrain, the mobile silvicultural vehicle comprising:
a steerable wheeled base frame;
a motor for imparting motion to the base frame; and
a least one shredder head operatively mounted onto the base frame and configured for processing the terrain as the mobile silvicultural vehicle travels thereover, each shredder head comprising:
an elongated support shaft about which the shredded head is mounted and configured to rotate;
a rotor mounted about the elongated support shaft and extending along the same, the rotor having a peripheral support surface area and a longitudinal axis of rotation; and
a plurality of first and second sections provided longitudinally along the peripheral support surface area of the rotor, each of said sections extending transversally with respect to the longitudinal axis of rotation of said rotor, the second sections being each disposed between pairs of first sections so to have an alternation of first and second sections longitudinally along the rotor, each of said sections comprising at least one supporting element for supporting at least one processing tool configured for cooperating with the terrain via a rotation of the rotor for processing said terrain and corresponding vegetation and rocks;
wherein first longitudinal gaps are defined between pairs of adjacent first sections, and second longitudinal gaps are defined between pairs of adjacent second sections, the supporting elements and corresponding processing tools of the first and second sections being shaped, positioned and sized within their respective sections so that the longitudinal gaps are smaller than longitudinal thicknesses of the corresponding processing tools so that rocks present in the terrain to be processed by the shredder head are impacted either by processing tools of adjacent sections or by processing tools of a same given section, so as to decrease average impact forces of the rocks per processing tool of the shredder head.

15. A mobile silvicultural vehicle according to claim 14, wherein the steerable wheeled base frame comprises a horizontally extending ground-clearing section, and first and second opposite vertical side sections.

16. A mobile silvicultural vehicle according to claim 15, wherein the ground-clearing and side sections define a tunnel-shaped passage through which immature trees of the terrain are allowed to pass as the base frame travels thereover, the base frame further comprising front and rear units and a universal joint coupling the front unit to the rear unit, front and rear wheeled assemblies mounted respectively to the front and rear units of the base frame, the front wheeled assembly comprising left and right front wheels respectively mounted to the vertical side sections of the front unit, and the rear wheeled assembly comprising left and right rear wheels mounted respectively to the vertical side sections of the rear unit.

17. A mobile silvicultural vehicle according to claim 16, wherein the front wheels are hydrostatic motor-wheels.

18. A mobile silvicultural vehicle according to claim 17, the hydrostatic motor-wheels are provided with chain threads.

19. A mobile silvicultural vehicle according to claim 18, wherein the mobile silvicultural vehicle comprises control means for controlling the steerable base frame and the motor.

20. A mobile silvicultural vehicle according to claim 19, wherein the front unit of the support frame comprises a cabin for housing an operator of the mobile silvicultural vehicle.
